(19) United States
(12) Patent Application Publication
(10) Pub. No.: US 2010/0034728 A1
(43) Pub. Date: Feb. 11, 2010

(54) Method for producing layer-structure nanoparticles

(75) Inventors: Jung Wook Seo, Gyeonggi-do (KR); Hyo Seun Nam, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/081,950

(22) Filed: Apr. 23, 2008

(30) Foreign Application Priority Data
Dec. 26, 2007 (KR) 10-2007-0137995

(51) Int. Cl. C01G 1/12; C01G 33/00; C01G 25/00; C01G 23/00; C01G 15/00

(52) U.S. Cl. 423/561.1

(57) ABSTRACT

Provided is a method of producing layer-structure nanoparticles, which includes the steps of: producing a liquid mixture by adding a metal halide precursor and a sulfur precursor into an organic solvent containing amine; producing layer-structure metal sulfide nanoparticles by heating the liquid mixture at a predetermined temperature; and separating the metal sulfide nanoparticles from the liquid mixture.

### CROSS-REFERENCE TO RELATED APPLICATIONS

This application claims the benefit of Korean Patent Application No. 10-2007-0137995 filed with the Korea Intellectual Property Office on Dec. 26, 2007, the disclosure of which is incorporated herein by reference.

### BACKGROUND OF THE INVENTION

1. Field of the Invention

The present invention relates to a method of producing the layered structured nanoparticles.

2. Description of the Related Art

Typical methods of producing metal nanoparticles are divided into a chemical synthesis method, a mechanical production method, and an electrical production method. In the mechanical production method using a mechanical force, it is difficult to produce high-purity particles because of impurities mixed during the process. Therefore, it is impossible to produce nano-size uniform particles.

In the electrical production method by electrolysis, a manufacturing time is lengthened, and concentration is so low that the efficiency decreases. The chemical synthesis method is roughly divided into a vapor phase deposition method and a liquid phase deposition method. Since the vapor phase deposition method requires an expensive equipment, the liquid phase deposition method is usually used, in which uniform particles can be produced at a low cost.

Recently, the layered structured nanoparticles are being produced by such methods. The layered nanoparticles are applied to various fields because of their unique layer structure.

For example, TiS₂, ZrS₂, and WS₂ nanoparticles can be applied as a hydrogen storage material. Since a coupling force between layers is weak, guest materials can be inserted between the respective layers so as to be used as an electrode of a lithium ion battery.

Further, since the structure of the nanoparticles is hardly deformed by a stimulus applied from outside, the nanoparticles can be used as a solid lubricant agent. Further, the nanoparticles can be used as hydrodesulfurization catalysts.

Further, the nanoparticles can be used as electronic materials for various fields.

Now, conventional methods of producing nanoparticles will be described briefly.

As for the conventional methods, there are provided a method in which hydrogen sulfide is injected into TiCl₄ to produce nanoparticles, a method in which Ti and sulfur are caused to react in the vacuum at 750° C., a method in which amorphous TiS₃ particles are thermally decomposed at a hydrogen atmosphere of 1000° C. to produce TiS₂ nanoparticles, and a method in which TiCl₄ and Na₂S are caused to react in a solution and are then subjected to the consecutive processes at a hydrogen atmosphere to produce layered structured nanoparticles.

The TiS₂ nanoparticles produced in such a manner have a fullerene-like shape or a one-dimensional nanotube shape.

Further, another method of producing nanoparticles, which is similar to the conventional methods of producing nanoparticles, is known. In this method, hydrogen sulfide and hydrogen gas are injected into metal oxide particles at a high temperature of more than 700° C. to produce WS₂ or MoS₂ nanoparticles. The nanoparticles produced by this method have a fullerene-like shape or a tube shape, like the TiS₂ nanoparticles. When the nanoparticles are used as a solid lubricant, the nanoparticles exhibit an excellent characteristic.

In the above-described methods, however, toxic hydrogen sulfide gas should be used. Further, depending on an amount of hydrogen and nitrogen gas added to a reactor, the shape and characteristic of products differ. Therefore, it is difficult to produce standardized nanoparticles with a layered structure.

Further, since the reaction between gas and solid is performed at a high temperature of 700 to 1000° C., an expensive equipment is required. Further, it is difficult to control the number of layers of the nanoparticles.

Further, when the layered structured nanoparticles are produced, a surfactant is not coated on the surfaces between the respective layers of the nanoparticles. Therefore, it is difficult to disperse the nanoparticles in a solvent.

Furthermore, MoS₂ bulk powder is mixed with a reaction promoter and a chemical transport agent (C₆₀ and I₂), and the resultant product is caused to react in the vacuum at about 700° C. for 22 days, thereby producing a bundle-type MoS₂ nanotube with a single wall. However, a produced amount is small, and an expensive equipment for synthesis in the vacuum is required.

The layered structured nanoparticles produced by the above-described conventional methods have a zero-dimensional or one-dimensional structure. Therefore, there is a limit in orientation where guest materials are inserted between the respective layers. Further, since the producing process is mostly performed in the vacuum or at a high temperature, an expensive equipment should be used. As a result, a manufacturing cost increases.

Further, since hydrogen or sulfide hydrogen gas should be used, the quality of nanoparticles differs depending on the amount of gas.

### SUMMARY OF THE INVENTION

An advantage of the present invention is that it provides a method of producing the layered structured nanoparticles in which a metal halide precursor and a sulfur precursor are mixed in an organic solvent containing amine and are then heated to thereby produce layered structured metal sulfide nanoparticles. In the method, various kinds of layered structured nanoparticles can be produced by the simple process of mixing and heating the precursors in liquid.

Additional aspects and advantages of the present general inventive concept will be set forth in part in the description which follows and, in part, will be obvious from the description, or may be learned by practice of the general inventive concept.

According to an aspect of the invention, a method of producing layered structured nanoparticles comprises the steps of: producing a liquid mixture by adding a metal halide precursor and a sulfur precursor into an organic solvent containing amine; producing layered structured metal sulfide nanoparticles by heating the liquid mixture at a predetermined temperature; and separating the metal sulfide nanoparticles from the liquid mixture.

In the producing of the liquid mixture, the metal halide precursor corresponding to a reactant with the sulfur precursor and the organic solvent containing amine may be selected from the group with a property of MₐX_{b} (M is metal, 1≦a≦7, X indicates F, Cl, Br, or I, 1≦b≦9).

The metal halide precursor may be selected from the group consisting of Ti, Tu, In, Mo, W, Zr, Nb, Sn, and Ta.

The sulfur precursor may be selected from the group consisting of sulfur, CS₂, diphenyldisulfide (PhSSPh), NH₂CSNH₂, CnH₂ₙ₊₁CSH, and CnH₂ₙ₊₁SSCnH₂ₙ₊₁.

The amine contained in the organic solvent, in which the metal halide precursor and the sulfur precursor are mixed, may be selected from the group consisting of organic amines (CₙNH₂, 4≦n≦30) including oleyl amine, dodecyl amine, lauryl amine, octyl amine, trioctyl amine, dioctyl amine, and hexadecyl amine.

The organic solvent, in which the metal halide precursor and the sulfur precursor are mixed, may be selected from the group consisting of an ether-based compound (CₙOCₙ, 4≦n≦30), a hydrocarbon compound (CₙH₂ₙ₊₂, 7≦n≦30), an unsaturated hydrocarbon compound (CₙH₂ₙ, 7≦n≦30), and organic acid (CₙCOOH, Cₙ: hydrocarbon, 5≦n≦30).

The ether-based compound may be selected from the group consisting of trioctylphosphine oxide (TOPO), alkylphosphine, octyl ether, benzyl ether, and phenyl ether.

The hydrocarbon compound may be selected from the group consisting of hexadecane, heptadecane, and octadecane.

The unsaturated hydrocarbon compound may be selected from the group consisting of octene, heptadecene, and octadecene.

The organic acid may be selected from the group consisting of oleic acid, lauric acid, stearic acid, mysteric acid, and hexadecanoic acid.

In the producing of the liquid mixture, a surfactant may be used, in addition to the metal halide precursor serving as a reactant which determine the shape of the layered structured nanoparticles.

The surfactant may be selected from the group consisting of organic amines (CₙNH₂, 4≦n≦30), including oleyl amine, dodecyl amine, lauryl amine, octyl amine, trioctyl amine, dioctyl amine, and hexadecyl amine, and alkanethiols (CₙSH, 4≦n≦30) including hexadecane thiol, dodecane thiol, heptadecane thiol, and octadecane thiol.

In the producing of the layered structured metal sulfide nanoparticles, the liquid mixture may be heated at 20 to 500° C. Preferably, the liquid mixture is heated at 60 to 400° C. Further, the liquid mixture is heated at 80 to 350° C.

In the producing of the layered structured metal sulfide nanoparticles, the reaction time for the metal halide precursor in the liquid mixture may be set to 1 to 8 hours.

The separating of layered structured nanoparticles may include the steps of: adding ethanol or acetone into a product generated when the metal halide precursor and the sulfur precursor react with the organic solvent containing amine, thereby precipitating the layered structured metal sulfide nanoparticles; and separating the precipitated metal sulfide nanoparticles by using a centrifugal separator or a filtration method.

In the producing of the layered structured metal sulfide nanoparticles, the number of layers of the metal sulfide nanoparticles may be controlled depending on the reaction temperature of the metal halide precursor.

The layered structured metal sulfide nanoparticles may be produced of any one selected from the group consisting of TiS₂, ZrS2₂, WS₂, MoS₂, NbS₂, TaS₂, SnS₂, and InS₂, depending on the kind of the metal halide precursor.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a diagram schematically showing a method of producing layered structured nanoparticles according to the invention;

FIG. 2 is a TEM (transmission electron microscope) photograph of TiS₂ nanoparticles produced by the method according to the invention;

FIG. 3 is a SEM (scanning electron microscope) photograph of TiS₂ nanoparticles produced by the method according to the invention;

FIGS. 4A and 4B are high-voltage high-resolution TEM photographs of TiS₂ nanoparticles produced by the method according to the invention.

FIG. 5 is a graph showing an X-ray diffraction pattern of TiS₂ nanoparticles produced by the method according to the invention;

FIGS. 6A and 6B are graphs showing an X-ray diffraction pattern of changes in the number of layers depending on the reaction temperature of TiS₂ nanoparticles produced by the method according to the invention;

FIG. 7 is a TEM photograph in which a change in size of ZrS₂ nanoparticles produced by the method according to the invention is analyzed;

FIG. 8 is a TEM photograph of WS₂ nanoparticles produced by the method according to the invention; and

FIG. 9 is a TEM photograph of NbS₂ nanoparticles produced by the method according to the invention.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

Hereinafter, a method of producing layered structured nanoparticles according to the present invention will be described in detail with reference to the accompanying drawings.

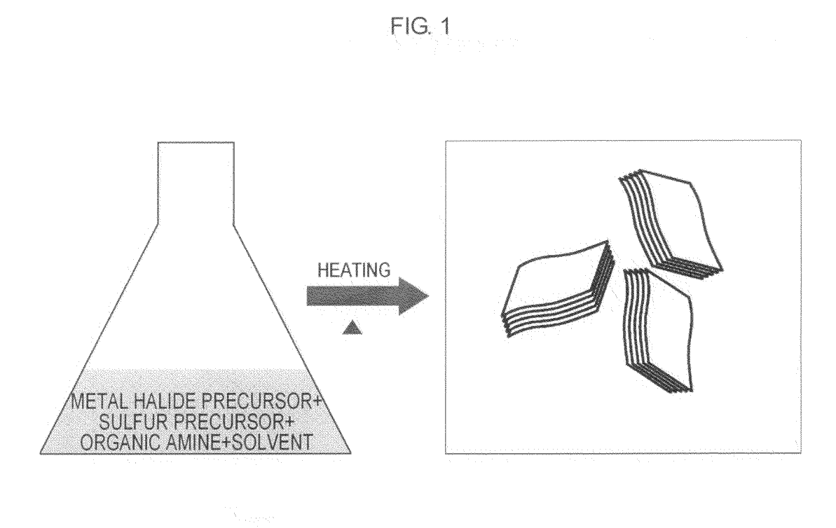

FIG. 1 is a diagram schematically showing a method of producing layered structured nanoparticles according to the invention.

First, as shown in FIG. 1, an organic solvent containing amine is prepared in a mixing container such as a flask or beaker, and a metal halide precursor and a sulfur precursor are mixed in the organic solvent containing amine.

Then, the liquid mixture obtained by mixing the metal halide precursor and the sulfur precursor in the organic solvent containing amine is heated at a predetermined temperature.

As the liquid mixture is heated, a product including metal-sulfide nanoparticles is generated. Then, ethanol or acetone is added to the product such that the metal-sulfide nanoparticles are precipitated. After that, the metal-sulfide nanoparticles are separated by a centrifugal separator to thereby produce layered structured nanoparticles.

More specifically, the metal halide precursor which is mixed with the sulfur precursor in the organic solvent containing amine is selected from the group consisting of Ti, Tu, In, Mo, W, Zr, Nb, Sn, and Ta with a property of MₐX_{b} (M represents metal, 1≦a≦7, X indicates F, Cl, Br, or I, 1≦b≦9).

The sulfur precursor which is mixed with the metal halide precursor in the organic solvent containing amine is selected from the group consisting of CS₂, diphenyldisulfide (PhSSPh), NH₂CSNH₂, CnH₂ₙ₊₁CSH, and CnH₂ₙ₊₁SSCnH₂ₙ₊₁.

Preferably, the metal halide precursor and the sulfur precursor are selected from the above-described compounds, but are not limited thereto.

Further, the amine contained in the organic solvent, in which the metal halide precursor and the sulfur precursor are mixed, is selected from the group consisting of organic amines (CₙNH₂, Cₙ: hydrocarbon, 4≦n≦30) such as oleyl amine, dodecyl amine, lauryl amine, octyl amine, trioctyl amine, dioctyl amine, and hexadecyl amine.

The organic solvent containing any one amine selected from the group consisting of organic amines is selected from the group consisting of an ether-based compound (CₙOCₙ, 4≦n≦30), a hydrocarbon compound (CₙH₂ₙ₊₂, 7≦n≦30), an unsaturated hydrocarbon compound (CₙH₂ₙ, 7≦n≦30), and organic acid (CₙCOOH, 5≦n≦30).

As for the ether-based compound, trioctylphosphine oxide (TOPO), alkylphosphine, octyl ether, benzyl ether, phenyl ether and so on may be used. As the hydrocarbon compound, hexadecane, heptadecane, octadecane and so on may be used.

Further, as for the unsaturated hydrocarbon compound, octene, heptadecene, octadecene and so on may be used. As for the organic acid, oleic acid, lauric acid, stearic acid, mysteric acid, and hexadecanoic acid may be used.

Meanwhile, in addition to the metal halide precursor serving as a reactant which determine the type of layer-structure nanoparticles, a surfactant may be used.

The surfactant is selected from the group consisting of organic amines (CₙNH₂, 4≦n≦30), such as oleyl amine, dodecyl amine, lauryl amine, octyl amine, trioctyl amine, dioctyl amine, and hexadecyl amine, and alkanethiols (CₙSH, 4≦n≦30) such as hexadecane thiol, dodecane thiol, heptadecane thiol, and octadecane thiol.

As the liquid mixture obtained by mixing the metal halide precursor and the sulfur precursor in the organic solvent containing amine is heated at a predetermined temperature, the halide precursor reacts with the sulfur precursor such that layered structured metal sulfide nanoparticles are produced. At this time, the liquid mixture is heated at a temperature of 20 to 500° C. such that the metal halide precursor becomes a metal sulfide.

Preferably, the liquid mixture is heated at a temperature of 60 to 400° C. More preferably, the liquid mixture is heated at a temperature of 80 to 350° C. such that the metal halide precursor reacts with the sulfur precursor in the organic solvent containing amine, thereby producing layered structured metal sulfide nanoparticles.

Preferably, the reaction time for the metal halide precursor in the liquid mixture is set to 1 to 8 hours.

Meanwhile, when the metal halide precursor reacts with the sulfur precursor by the heating such that the layer-structure metal sulfide nanoparticles are produced, ethanol or acetone is added to separate and collect the layered structured metal sulfide nanoparticles.

At this time, the separation of the layered structured metal sulfide nanoparticles is performed by a centrifugal separator. In some cases, the separation may be performed by a filtration method.

The layered structured nanoparticles produced by the above-described process have a two-dimensional layer structure depending on the kind of the metal halide precursor reacting with the sulfur precursor.

In this case, the number of layers of the nanoparticles can be controlled depending on the reaction temperature of the metal halide precursor.

That is, as the reaction temperature of the metal halide precursor is low, the number of layers increases. This will be described in more detail.

### First Embodiment

### Method of Producing TiS₂ Nanoparticles

First, 90 μl of TiCl₄ and 3 g of refined oleyl amine are put into a flask and are then heat in an argon atmosphere at a temperature of 300° C. At this temperature, 0.12 ml of carbon disulfide is mixed. Then, the liquid mixture is heated at a temperature of 300° C.

After the liquid mixture is maintained at 300° C. for 30 minutes, the liquid mixture is cooled down to the normal temperature, and 20 ml of acetone is then added to precipitate layer-structure nanoparticles. The precipitated layered structured nanoparticles are collected using a centrifugal separator.

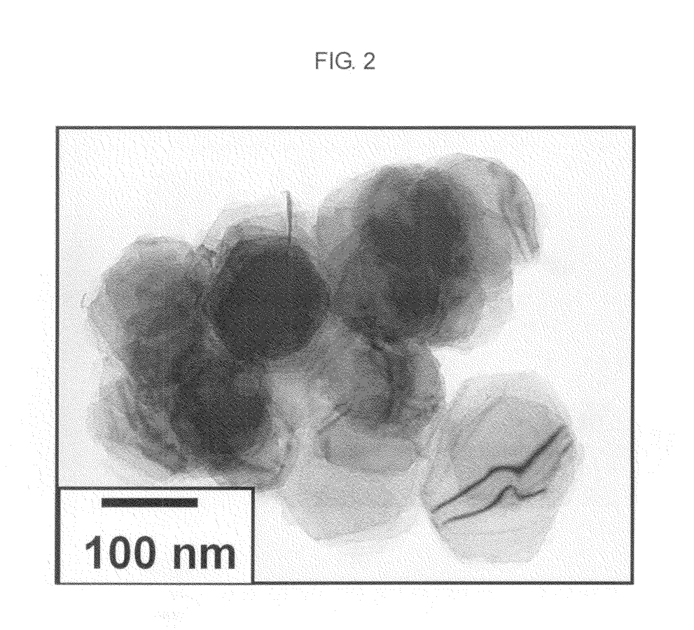

Then, 20 μl of solution containing the collected TiS₂ nanoparticles is dropped on a TEM grid coated with a carbon grid and is dried for about 20 minutes. Then, the solution is observed through a transmission electron microscope (EF-TEM) (Zeiss, acceleration voltage: 100 kv). FIG. 2 shows the observation result.

As shown in FIG. 2, it can be found that TiS₂ nanoparticles have a layered structured sheet shape.

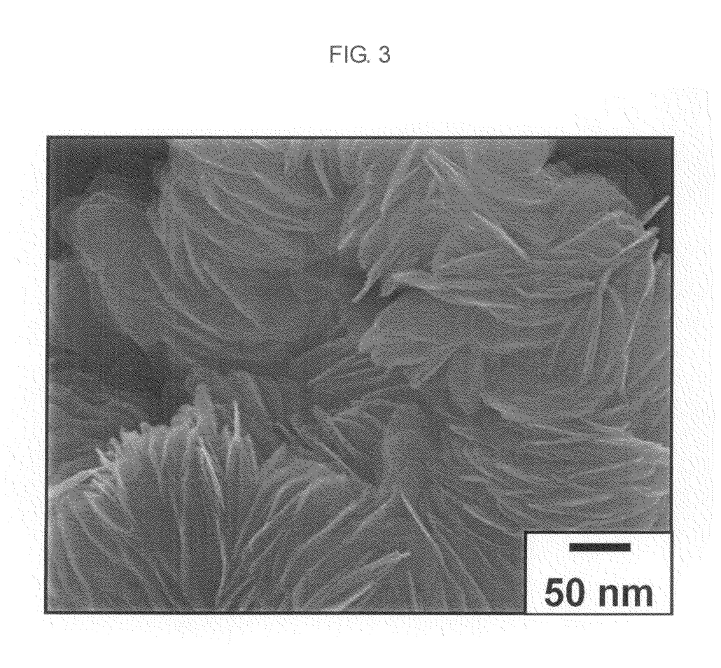

Further, the collected TiS₂ nanoparticles are observed through a scanning electron microscope. FIG. 3 shows the observation result. Like the analysis result of the EF-TEM, it can be found that the TiS₂ nanoparticles have a layered structured sheet shape.

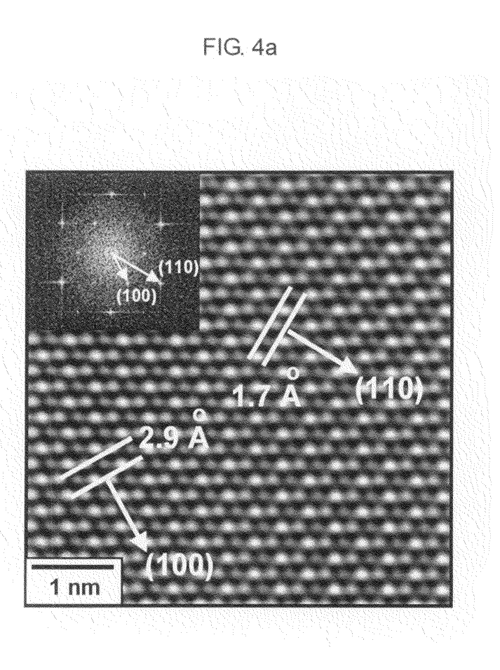

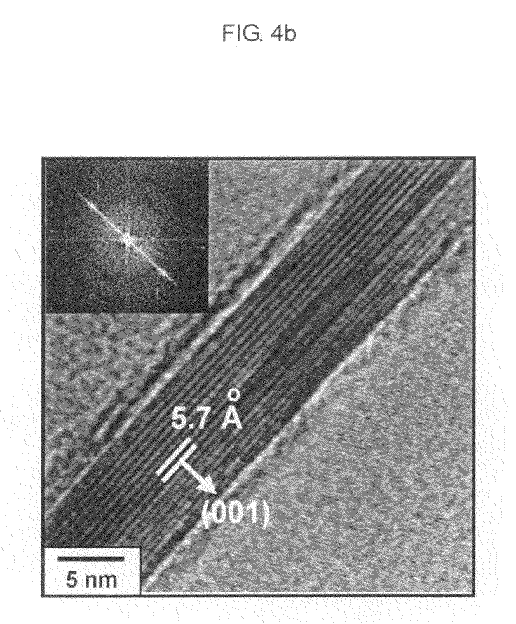

Meanwhile, the layered structure of the TiS₂ nanoparticles is observed through a high-voltage high-resolution TEM (Jeol, acceleration voltage: 1250 kv), in order to more clearly observe the layered structure. FIGS. 4A and 4B show the observation result.

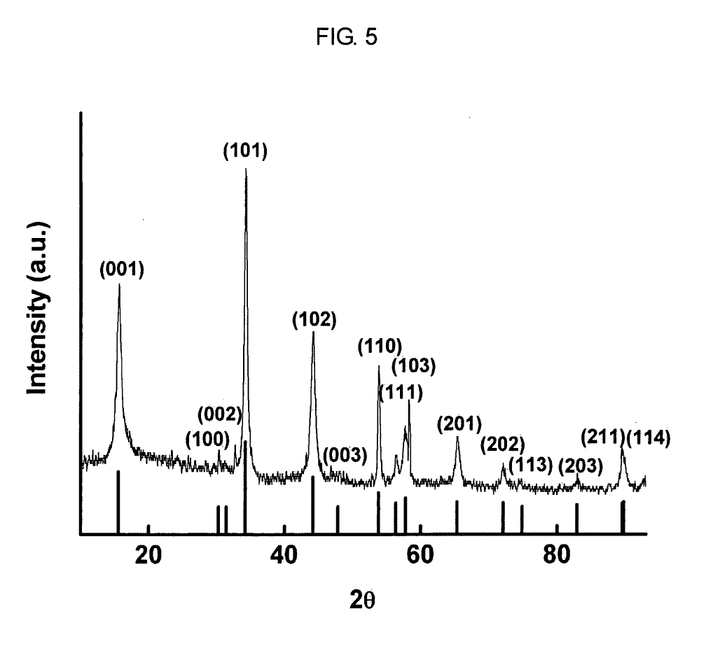

Through the electron diffraction analysis and the high-resolution TEM analysis, it can be found that the TiS₂ nanoparticles obtained in this embodiment have a hexagonal single-crystal structure. In addition to the TEM analysis, the crystal structure of the nanoparticles is analyzed using an X-ray diffractometer (XRD). FIG. 5 shows the analysis result indicating that the nanoparticles have a hexagonal single-crystal structure.

In the layered structured TiS₂ nanoparticles produced in this embodiment, a distance between lattices is consistent with that of the hexagonal crystal structure, and an inter-surface distance with (001) surface coincides. Therefore, it can be found that the TiS₂ nanoparticles have a layered structure.

[First Modification]

Method of Controlling the Number of Layers of Tis₂ Nanoparticles

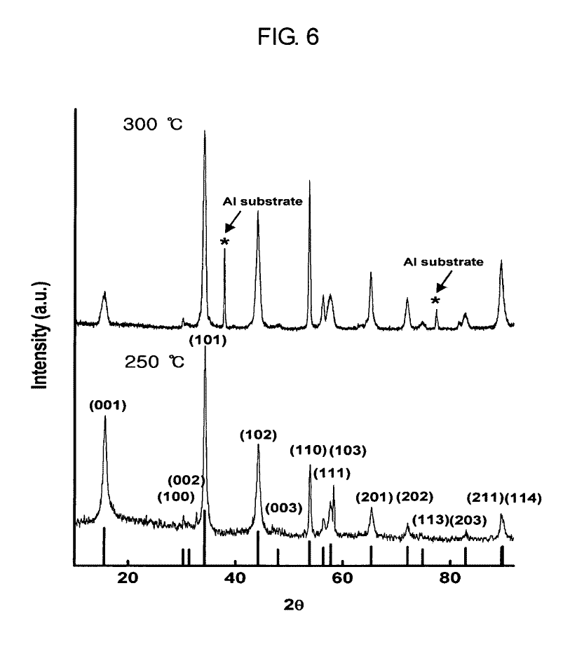

Through the same producing method as that of the first embodiment, a liquid mixture is heated to produce TiS₂ nanoparticles. Further, CS₂ is mixed at 300° C. FIG. 6 shows an XRD analysis result obtained in a state where the reaction time is set the same as that of the first embodiment.

Referring to FIG. 6, the XRD analysis pattern obtained when CS₂ is mixed at 300° C. is compared with an XRD analysis pattern obtained at 250° C. When CS₂ is mixed at 300° C., the peak intensity and area of (001) surface are weaker and larger than the peak intensity and area of (001) surface obtained by mixing CS₂ at 250° C., respectively.

Therefore, it can be judged that the number of layers of nanoparticles obtained at 300° C. according to the modification is smaller than the number of layers of nanoparticles produced at 250° C.

### Second Embodiment

### Method of Producing ZrS₂ Nanoparticles

ZrS₂ nanoparticles are produced by the same method as that of the first embodiment. In this embodiment, ZrCl₄ is used instead of TiCl₄ so as to produce the ZrS₂ nanoparticles.

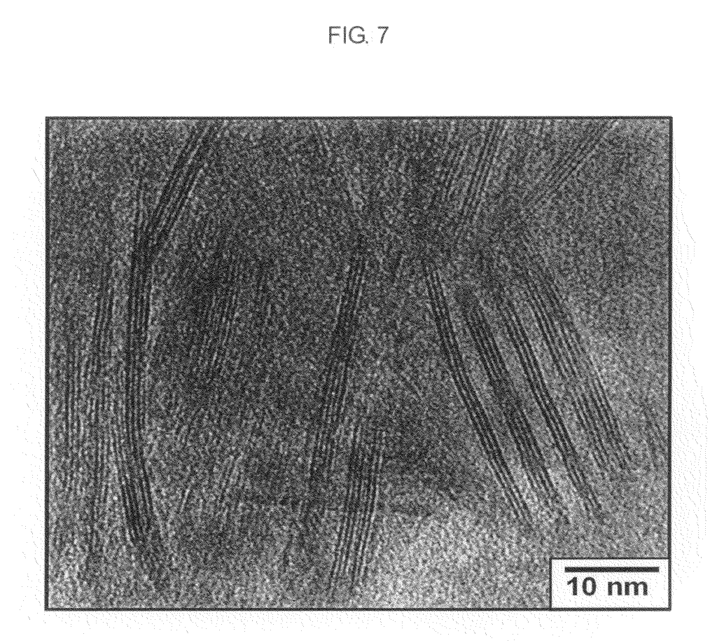

FIG. 7 shows a TEM observation result of the ZrS₂ nanoparticles produced in such a manner.

### Third Embodiment

### Method of Producing WS₂ Nanoparticles

WS₂ nanoparticles are produced by the same method as that of the first embodiment. In this embodiment, WCl₄ is used instead of TiCl₄ so as to produce the WS₂ nanoparticles.

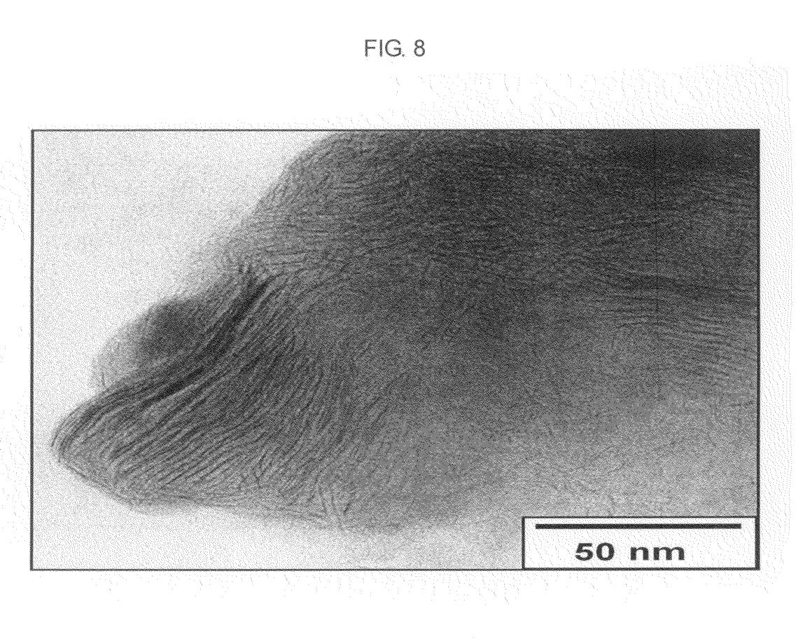

FIG. 8 shows a TEM observation result of the WS₂ nanoparticles produced in such a manner.

### Fourth Embodiment

### Method of Producing NbS₂ Nanoparticles

NbS₂ nanoparticles are produced by the same method as that of the first embodiment. In this embodiment, NbCl₄ is used instead of TiCl₄ so as to produce the NbS₂ nanoparticles.

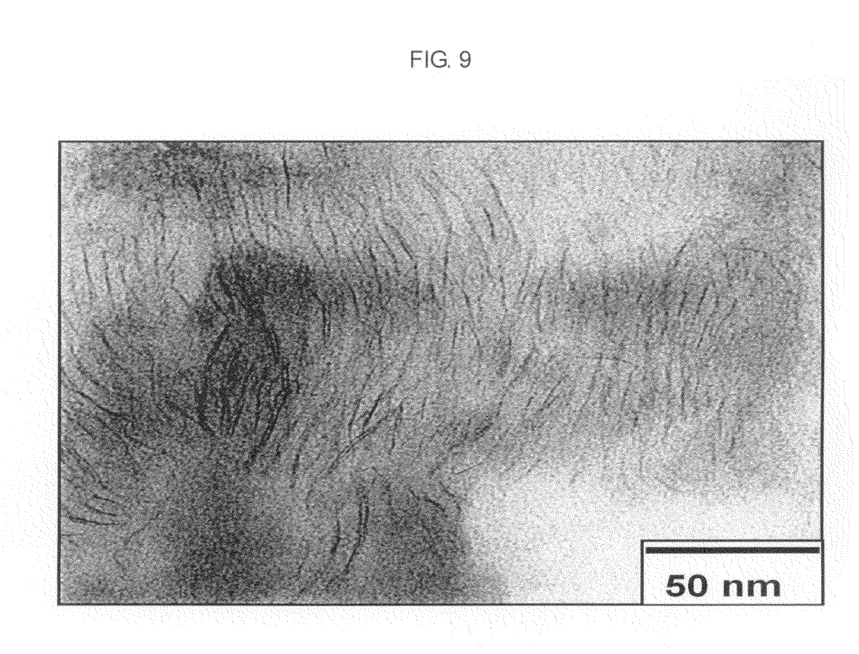

FIG. 9 shows a TEM observation result of the NbS₂ nanoparticles produced in such a manner.

According to the present invention, the layered structured nanoparticles can be produced by the simple process in which the metal halide precursor and the sulfur precursor are mixed in the organic solvent containing amine and are then heated. Further, as the kind of the metal halide precursor is changed, various kinds of layered structured nanoparticles can be produced.

Further, the layered structured nanoparticles can be applied to various fields, serving as a hydrogen storage material, a solid lubricant agent, a hydrodesulfurization catalyst, and an electronic material such as an electrode of lithium ion batteries or the like.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of producing layered structured nanoparticles, comprising the steps of:
producing a liquid mixture by adding a metal halide precursor and a sulfur precursor into an organic solvent containing amine;
producing layered structured metal sulfide nanoparticles by heating the liquid mixture at a predetermined temperature; and
separating the metal sulfide nanoparticles from the liquid mixture.

2. The method according to claim 1, wherein in the producing of the liquid mixture, the metal halide precursor corresponding to a reactant with the sulfur precursor and the organic solvent containing amine is selected from the group with a property of MₐX_{b} (M is metal, 1≦a≦7, X indicates F, Cl, Br, or I, 1≦b≦9).

3. The method according to claim 2, wherein the metal halide precursor is selected from the group consisting of Ti, Tu, In, Mo, W, Zr, Nb, Sn, and Ta.

4. The method according to claim 1, wherein the sulfur precursor is selected from the group consisting of sulfur, CS₂, diphenyldisulfide (PhSSPh), NH₂CSNH₂, CnH₂ₙ₊₁CSH, and CnH₂ₙ₊₁SSCₙH₂ₙ₊₁.

5. The method according to claim 1, wherein the amine contained in the organic solvent, in which the metal halide precursor and the sulfur precursor are mixed, is selected from the group consisting of organic amines (CₙNH₂, 4≦n≦30) including oleyl amine, dodecyl amine, lauryl amine, octyl amine, trioctyl amine, dioctyl amine, and hexadecyl amine.

6. The method according to claim 1, wherein the organic solvent, in which the metal halide precursor and the sulfur precursor are mixed, is selected from the group consisting of an ether-based compound (CₙOCₙ, 4≦n≦30), a hydrocarbon compound (CₙH₂ₙ₊₂, 7≦n≦30), an unsaturated hydrocarbon compound (CₙH₂ₙ, 7≦n≦30), and organic acid (CₙCOOH, Cₙ: hydrocarbon, 5≦n≦30).

7. The method according to claim 6, wherein the ether-based compound is selected from the group consisting of trioctylphosphine oxide (TOPO), alkylphosphine, octyl ether, benzyl ether, and phenyl ether.

8. The method according to claim 6, wherein the hydrocarbon compound is selected from the group consisting of hexadecane, heptadecane, and octadecane.

9. The method according to claim 6, wherein the unsaturated hydrocarbon compound is selected from the group consisting of octene, heptadecene, and octadecene.

10. The method according to claim 6, wherein the organic acid is selected from the group consisting of oleic acid, lauric acid, stearic acid, mysteric acid, and hexadecanoic acid.

11. The method according to claim 1, wherein in the producing of the liquid mixture, a surfactant is used, in addition to the metal halide precursor serving as a reactant which determine the shape of the layered structured nanoparticles.

12. The method according to claim 11, wherein the surfactant is selected from the group consisting of organic amines (CₙNH₂, 4≦n≦30), including oleyl amine, dodecyl amine, lauryl amine, octyl amine, trioctyl amine, dioctyl amine, and hexadecyl amine, and alkanethiols (CₙSH, 4≦n≦30) including hexadecane thiol, dodecane thiol, heptadecane thiol, and octadecane thiol.

13. The method according to claim 1, wherein in the producing of the layered structured metal sulfide nanoparticles, the liquid mixture is heated at 20 to 500° C.

14. The method according to claim 13, wherein the liquid mixture is heated at 60 to 400° C.

15. The method according to claim 13, wherein the liquid mixture is heated at 80 to 350° C.

16. The method according to claim 1, wherein in the producing of the layered structured metal sulfide nanoparticles, the reaction time for the metal halide precursor in the liquid mixture is set to 1 to 8 hours.

17. The method according to claim 1, wherein the separating of the layered structured nanoparticles includes the steps of:
adding ethanol or acetone into a product generated when the metal halide precursor and the sulfur precursor react with the organic solvent containing amine, thereby precipitating the layered structured metal sulfide nanoparticles; and
separating the precipitated metal sulfide nanoparticles by using a centrifugal separator or a filtration method.

18. The method according to claim 1, in the producing of the layered structured metal sulfide nanoparticles, the number of layers of the metal sulfide nanoparticles is controlled depending on the reaction temperature of the metal halide precursor.

19. The method according to claim 1, wherein the layered structured metal sulfide nanoparticles are produced of any one selected from the group consisting of TiS₂, ZrS2₂, WS₂, MoS₂, NbS₂, TaS₂, SnS₂, and InS₂, depending on the kind of the metal halide precursor.
